(19) United States
(12) Patent Application Publication
(10) Pub. No.: US 2025/0168881 A1
(43) Pub. Date: May 22, 2025

(54) APPARATUS AND METHOD FOR SOUNDING IN MULTIPLE ACCESS POINTS (MAP) NETWORK

(71) Applicant: SAMSUNG ELECTRONICS CO, LTD., Suwon-si (KR)

(72) Inventors: Myeongjin KIM, Suwon-si (KR); Jinmin KIM, Suwon-si (KR); Eunsung JEON, Suwon-si (KR); Chulho CHUNG, Suwon-si (KR)

(73) Assignee: SAMSUNG ELECTRONICS CO,LTD., Suwon-si (KR)

(21) Appl. No.: 18/937,508

(22) Filed: Nov. 5, 2024

(30) Foreign Application Priority Data
Nov. 20, 2023 (KR) 10-2013-0161029

(51) Int. Cl. H04W 74/0816; H04W 74/08; H04W 84/12

(52) U.S. Cl. CPC H04W 74/0816; H04W 74/0866; H04W 84/12

(57) ABSTRACT

An method of a first apparatus in a wireless local area network (WLAN) system, includes: receiving, from a second apparatus, a multiple access points (MAP) network frame; identifying, from the MAP network frame, a serial null data packet (NDP) transmission method for MAP sounding; identifying, from the MAP network frame, a NDP transmission order of the first apparatus within a NDP transmission period; and based on the NDP transmission order, transmitting, to a third apparatus, a first NDP within the NDP transmission period.

### CROSS-REFERENCE TO RELATED APPLICATION

This application is based on and claims priority under 35 U.S.C. § 119 to Korean Patent Application No. 10-2023-0161029, filed on Nov. 20, 2023, in the Korean Intellectual Property Office, the disclosure of which is incorporated by reference herein in its entirety.

### BACKGROUND

The disclosure relates to wireless communication, and more particularly, to sounding for channel estimation in a multiple access points (MAP) network of a wireless local area network (WLAN) system.

As an example of wireless communication, a wireless local area network (WLAN) is a technology that connects two or more devices using a wireless signal transmission method. The WLAN technology is based on the Institute of Electrical and Electronics Engineers (IEEE) 802.11 standard that has evolved into 802.11b, 802.11a, 802.11g, 802.11n, 802.11ac, and 802.11ax, which can support transmission rates up to 1 Giga byte (GB)/second(s) based on the orthogonal frequency-division multiplexing (OFDM) technology.

As the number of access points (APs) in a WLAN system rapidly increases in order to provide the WLAN to more stations (STAs), interference between APs with different basic service sets (BSSs) increases, which causes a decrease in the overall performance of the WLAN system. To reduce the interference between the APs, a technology for a multiple access point (MAP) network (hereinafter, referred to as a MAP network) has been proposed.

### SUMMARY

Provided are an apparatus and a method for efficiently performing sounding for channel estimation in a multiple access points (MAP) network of a wireless local area network (WLAN) system.

According to an aspect of the disclosure, an method of a first apparatus in a wireless local area network (WLAN) system, includes: receiving, from a second apparatus, a multiple access points (MAP) network frame; identifying, from the MAP network frame, a serial null data packet (NDP) transmission method for MAP sounding; identifying, from the MAP network frame, a NDP transmission order of the first apparatus within a NDP transmission period; and based on the NDP transmission order, transmitting, to a third apparatus, a first NDP within the NDP transmission period.

According to an aspect of the disclosure, an method of a first apparatus in a wireless local area network (WLAN) system, the method includes: determining a plurality of second apparatuses and a plurality of third apparatuses configured to participate in multiple access points (MAP) sounding, wherein the plurality of second apparatuses respectively correspond to a plurality of access points (APs) and the plurality of third apparatuses respectively correspond to a plurality of stations; determining a serial null data packet (NDP) transmission method for the MAP sounding; determining a NDP transmission order of the first apparatus and the plurality of second apparatuses within a NDP transmission period; generating a MAP network frame indicating the serial NDP transmission method and the NDP transmission order; and transmitting the MAP network frame to the plurality of second apparatuses and the plurality of third apparatuses.

According to an aspect of the disclosure, a first apparatus includes: a transceiver configured to receive a multiple access points (MAP) network frame from a second apparatus; and a processing circuit configured to: identify a null data packet (NDP) transmission order of the first apparatus from the MAP network frame in a serial NDP transmission method for MAP sounding and determine a transmission timing of a first NDP based on the NDP transmission order, and transmit the first NDP to a third apparatus through the transceiver, based on the determined transmission timing of the first NDP.

### BRIEF DESCRIPTION OF THE DRAWINGS

Embodiments will be more clearly understood from the following detailed description taken in conjunction with the accompanying drawings in which:

FIG. 1 shows a wireless communication system according to an embodiment;

FIG. 2 is a block diagram showing a wireless communication system according to an embodiment;

FIG. 3 is a timing diagram showing Multiple Access Points (MAP) sounding according to an embodiment;

FIGS. 4A and 4B illustrate a MAP interference improvement operation performed based on channel state information collected through MAP sounding according to an embodiment;

FIG. 5 is a flowchart illustrating a method of determining a null data packet (NDP) transmission order in a sharing access point (AP), according to an embodiment;

FIG. 6 illustrates a method of determining a NDP transmission order in a sharing AP, according to an embodiment;

FIGS. 7A and 7B illustrate a method of determining a NDP transmission order in a sharing AP, according to an embodiment;

FIG. 8A shows a MAP network frame according to an embodiment;

FIG. 8B shows a common information field of FIG. 8A, and FIG. 8C shows an AP information field of FIG. 8A;

FIG. 9 is a diagram specifically showing a MAP network frame indicating a NDP transmission order, according to an embodiment;

FIG. 10 is a flowchart illustrating an operation method of a shared AP, according to an embodiment;

FIG. 11 is a diagram specifically showing a MAP network frame indicating a NDP transmission order, according to an embodiment;

FIG. 12 is a flowchart illustrating an operation method of a shared AP, according to an embodiment;

FIG. 13 is a flowchart illustrating an operation method of a sharing AP, according to an embodiment;

FIG. 14 is a flowchart illustrating an operation method of a sharing AP, according to an embodiment;

FIG. 15 is a flowchart illustrating an operation method in a MAP network, according to an embodiment;

FIG. 16 shows examples of apparatuses for wireless communication according to an embodiment; and

FIG. 17 is a block diagram specifically showing an apparatus according to an embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

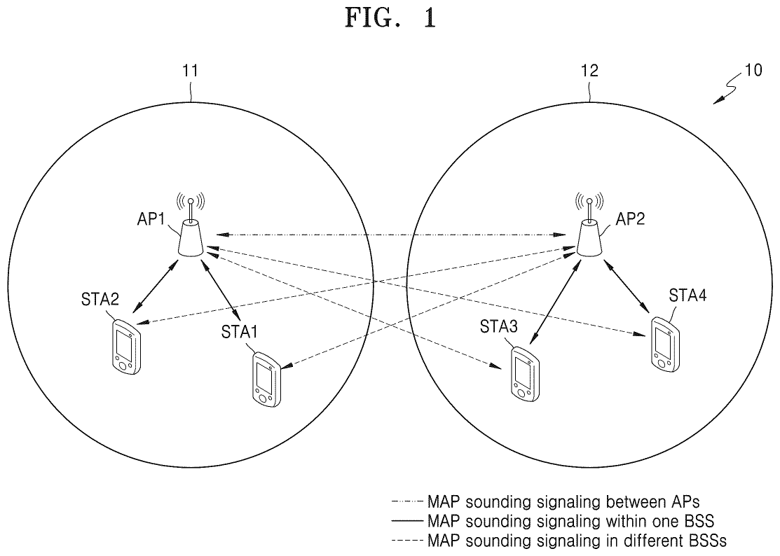

FIG. 1 shows a wireless communication system 10 according to an embodiment. More specifically, FIG. 1 shows a wireless local area network (WLAN) system as an example of the wireless communication system 10.

In the following detailed descriptions of embodiments, orthogonal frequency division multiplexing (OFDM) or orthogonal frequency division multiplexing access (OFDMA) based wireless communication systems, particularly, the IEEE 802.11 standard may be a main target. However, the main gist of the disclosure may be applicable to other communication systems (for example, a cellular communication system, such as long term evolution (LTE), LTE-Advanced (LTE-A), new radio (NR), wireless broadband (WiBro), and global system for mobile communication (GSM), or a short-range communication system, such as Bluetooth and near field communication (NFC)) having similar technical backgrounds and channel types, through slight modifications within a range greatly not deviating from the scope of the disclosure, under a determination by a person skilled in the technical field of the disclosure.

Also, various functions, which will be described below, may be implemented or supported by an artificial intelligence (AI) technology or one or more computer programs, and each of the programs may be written in computer-readable program codes and executed on computer-readable media. The terms “application” and “program” may refer to one or more computer programs, software components, instruction sets, procedures, functions, objects, classes, instances, associated data, or part thereof, suitably implemented in computer-readable program codes. The “computer-readable program codes” may include all types of computer codes including source codes, object codes, and execution codes. The “computer-readable media” may include all types of media accessible by a computer, such as read only memory (ROM), random access memory (RAM), a hard disk drive (HDD), a compact disc (CD), a digital video disc (DVD) or other types of memory. “Non-transitory” computer-readable media may exclude wired, wireless, optical, or other communication links that transmit transitory electrical or other signals. The non-transitory computer-readable media may include media where data can be permanently stored and media where data can be stored and later overwritten, such as a rewritable optical disc or an erasable memory device.

In one or more embodiments which will be described below, a hardware approach method will be described as an example. However, the one or more embodiments may include a technology using both hardware and software and accordingly, the one or more embodiments may not exclude a software-based approach method.

Also, in the following descriptions, the term indicating control information, the term indicating an entry, the term indicating network entity, the term indicating messages, the term indicating a component of a device, etc. are examples. Accordingly, the disclosure is not limited to these terms, and other terms having equivalent technical meanings may be used.

Referring to FIG. 1, the wireless communication system 10 may include first and second access points AP1 and AP2, a first station STA1, a second station STA2, a third station STA3, and a fourth station STA4. The first and second access points AP1 and AP2 may be connected to a network including the Internet, an internet protocol (IP) network, or another arbitrary network. The first access point AP1 may provide access to a network to the first and second stations STA1 and STA2 within a first basic service set (BSS) 11, and the second access point AP2 may provide access to a network to the third and fourth stations STA3 and STA4 within a second BSS 12. In the disclosure, a BSS may be understood as a coverage area where APs are capable of controlling access to a network. In some embodiments, the first and second access points AP1 and AP2 may communicate with at least one station among the first station STA1, the second station STA2, the third station STA3, or the fourth station STA4, based on wireless fidelity (Wi-Fi) or another arbitrary WLAN access technology.

An access point may be called a router, a gateway, etc., and a station may be called a mobile station, a subscriber station, a terminal, a mobile terminal, a wireless terminal, user equipment, a user device, etc. The station may be a mobile device, such as a mobile phone, a laptop computer, and a wearable device, or the station may be a stationary device, such as a desktop computer and a smart television (TV). In the disclosure, an access point is interchangeably referred to as an AP, and a station is interchangeably referred to as a STA.

The first and second access points AP1 and AP2 may assign at least one resource unit RU to at least one of the first to fourth stations STA1 to STA4. The first and second access points AP1 and AP2 may transmit data to the at least one station through the at least one resource unit RU, and the at least one station may receive data from the first and second access points AP1 and AP2 through the at least one resource unit RU. In 802.11ax, the first and second access points AP1 and AP2 may assign a single resource unit to at least one station. In 802.11be (for example, extremely high throughput (EHT) or next-generation IEEE 802.11 standards), the first and second access points AP1 and AP2 may assign a multi-resource unit (MRU) including two or more resource units to at least one station. For example, the first access point AP1 may assign a multi-resource unit to at least one of the first and second stations STA1 and STA2, and transmit data through the multi-resource unit.

The first and second access points AP1 and AP2 may communicate with the first to fourth stations STA1, STA2, STA3, and STA4 based on a beamforming scheme. For example, the first access point AP1 may perform single-user beamforming with the first station STA1 to improve reception performance in communication with the first station STA1, or the first access point AP1 may perform multi-user beamforming with the first and second stations STA1 and STA2 to remove interference between the first station STA1 and the second station STA2 and thereby improve reception performance in overall communication with the first and second stations STA1 and STA2.

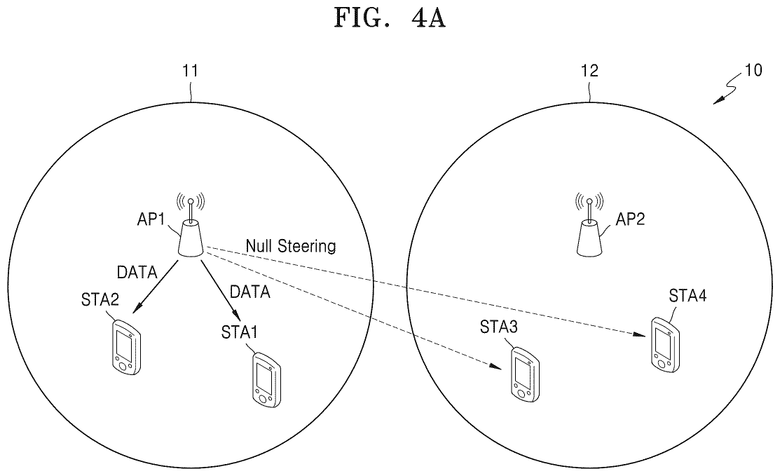

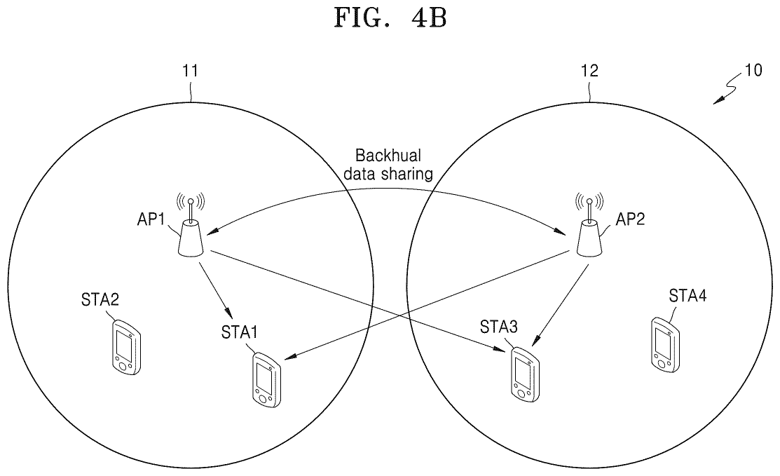

In an environment of a multiple access point (MAP) network (hereinafter, referred to as a MAP network) including the first and second access points AP1 and AP2, one communication between the first access point AP1 and the first and second stations STA1 and STA2 within the first BSS 11 may interfere with another communication between the second access point AP2 and the third and fourth stations STA3 and STA4 within the second BSS 12. To reduce the interference, the first access point AP1 and the second access point AP2 may selectively perform any one of a coordinated beamforming operation or a joint transmission operation. Details about the coordinated beamforming operation and the joint transmission operation will be described with reference to FIGS. 4A and 4B.

To perform the coordinated beamforming operation or the joint transmission operation, the first access point AP1 and the second access point AP2 may need channel state information with respect to stations within other BSSs. For example, the first access point AP1 may need channel state information with respect to the third and fourth stations STA3 and STA4 within the second BSS 12, as well as channel state information with respect to the first and second stations STA1 and STA2 within the first BSS 11. Also, the second access point AP2 may need channel state information with respect to the first and second stations STA1 and STA2 within the first BSS 11, as well as channel state information with respect to the third and fourth stations STA3 and STA4 within the second BSS 12.

In the disclosure, the first and second access points AP1 and AP2 are capable of obtaining channel state information with respect to the first to fourth stations STA1, STA2, STA3, and STA4 within the first and second BSSs 11 and 12 to perform a ‘MAP interference improvement operation’ for reducing interference. In the disclosure, the ‘MAP interference improvement operation’ may be an operation capable of reducing interference between access points in an environment of a MAP network, and may additionally require channel state information of stations within other BSSs.

In the MAP network having the first and second access points AP1 and AP2 according to an embodiment, MAP sounding for efficiently and effectively obtaining channel state information from the first to fourth stations STA1, STA2, STA3, and STA4 within the first and second BSSs 11 and 12 may be performed. In the disclosure, MAP sounding may include a plurality of operations by which access points (participating in the MAP sounding) collect channel state information from stations participating in the MAP sounding.

According to an embodiment, the first access point AP1 may perform a MAP sounding signaling with the second access point AP2. The MAP sounding signaling between the first and second access points AP1 and AP2 may include a signaling for determining a control subject of the MAP sounding and an operation of transmitting/receiving a MAP network frame in the MAP sounding. The following descriptions will be given when the first and second access points AP1 and AP2 and the first to fourth stations STA1, STA2, STA3, and STA4 participate in MAP sounding, as shown in FIG. 1. However, this may be an embodiment, and the disclosure is not limited to this. In other embodiments, the numbers of access points and stations participating in MAP sounding may change.

According to an embodiment, the first and second access points AP1 and AP2 may respectively perform a MAP sounding signaling within the first and second BSSs 11 and 12 that the first and second access point AP1 and AP2 control, respectively. For example, the MAP sounding signaling within the first BSS 11 may include an operation of transmitting/receiving a null data packet (NDP) between the first access point AP1 and the first and second stations STA1 and STA2, and an operation of transmitting/receiving a MAP sounding feedback including channel state information between the first access point AP1 and the first and second stations STA1 and STA2. Also, the MAP sounding signaling within the second BSS 12 may include an operation of transmitting/receiving a NDP between the second access point AP2 and the third and fourth stations STA3 and STA4, and an operation of transmitting/receiving a MAP sounding feedback including channel state information between the second access point AP2 and the third and fourth stations STA3 and STA4.

According to an embodiment, the first and second access points AP1 and AP2 may respectively perform the MAP sounding signaling with the other first and second BSSs 11 and 12. For example, MAP sounding signaling with the other second BSS 12 may include an operation of transmitting/receiving a NDP between the first access point AP1 and the third and fourth stations STA3 and STA4, and an operation of transmitting/receiving a MAP sounding feedback including channel state information between the first access point AP1 and the third and fourth stations STA3 and STA4. Also, MAP sounding signaling with the other first BSS 11 may include an operation of transmitting/receiving a NDP between the second access point AP2 and the first and second stations STA1 and STA2, and an operation of transmitting/receiving a MAP sounding feedback including channel state information between the second access point AP2 and the first and second stations STA1 and STA2.

Hereinafter, when the first access point AP1 is a control subject for MAP sounding, a series of operations for each MAP subject will be described. In the disclosure, an access point which is a control subject for MAP sounding may be referred to as a sharing access point (or a ‘sharing AP’), and the remaining access point for the MAP sounding may be referred to as a shared access point (or a ‘shared AP’).

According to an embodiment, in the MAP sounding signaling between the first access point AP1 and the second access point AP2, the first access point AP1 and the second access point AP2 may exchange MAP network-related information including information about their own first and second BSSs 11 and 12 with each other, and determine a control subject for the MAP sounding to the first access point AP1. According to some embodiments, information about the first and second BSSs 11 and 12 may include information about stations belonging to the corresponding BSSs.

First, embodiments will be described based on the first access point AP1 that is a sharing access point.

According to an embodiment, the first access point AP1 may determine a shared access point and stations that participate in MAP sounding. FIG. 1 showing only the first and second access points AP1 and AP2, which are only an example embodiment. In other embodiments, the MAP network may be configured with (or may include) more access points. In the case of FIG. 1, the first access point AP1 may determine shared access points participating in MAP sounding from among a plurality of access points. More specifically, the first access point AP1 may determine the second access point AP2 and the first to fourth stations STA1, STA2, STA3, and STA4 as an access point and stations that participate in MAP sounding.

According to an embodiment, the first access point AP1 may determine a NDP transmission method for MAP sounding. The NDP transmission method may be applied in common to the first and second access points AP1 and AP2 participating in MAP sounding upon transmission of NDPs to the first to fourth stations STA1, STA2, STA3, and STA4 participating in MAP sounding. According to an embodiment, the NDP transmission method may include a serial NDP transmission method in which access points serially transmit NDPs in a preset order to stations within a NDP transmission period, and a joint NDP transmission method in which the first and second access points AP1 and AP2 transmit NDPs simultaneously to the first to fourth stations STA1, STA2, STA3, and STA4 within a NDP transmission period.

According to an embodiment, the first access point AP1 may determine the serial NDP transmission method, and in this case, the first access point AP1 may determine a NDP transmission order of the first and second access points AP1 and AP2 participating in MAP sounding. The first access point AP1 may determine an order of transmitting NDPs to the first to fourth stations STA1, STA2, STA3, and STA4 participating in MAP sounding based on the first and second access points AP1 and AP2 participating in MAP sounding.

According to an embodiment, the first access point AP1 may randomly determine a NDP transmission order of the first and second access points AP1 and AP2 participating in MAP sounding. According to an embodiment, the first access point AP1 may determine a NDP transmission order of the remaining second access point AP2 by considering a fixed NDP transmission order of the first access point AP1 which is a sharing AP among the first and second access points AP1 and AP2 participating in MAP sounding. According to an embodiment, the first access point AP1 may measure an interference environment of the MAP network and determine a NDP transmission order of the first and second access points AP1 and AP2 participating in MAP sounding based on the measured result.

Hereinafter, when the NDP transmission method is the serial NDP transmission method, embodiments will be described.

According to an embodiment, the first access point AP1 may generate a MAP network frame that indicates a plurality of access points and a plurality of stations participating in MAP sounding, the serial NDP transmission method, and a NDP transmission order of the plurality of access points. For example, the first access point AP1 may generate a MAP network frame that indicates the first and second access points AP1 and AP2 and the first to fourth stations STA1, STA2, STA3, and STA4 participating in MAP sounding, the serial NDP transmission method, and a NDP transmission order of the first and second access points AP1 and AP2. In the disclosure, a frame, field, or subfield indicating specific information may be understood to be a frame, field, or subfield including the specific information.

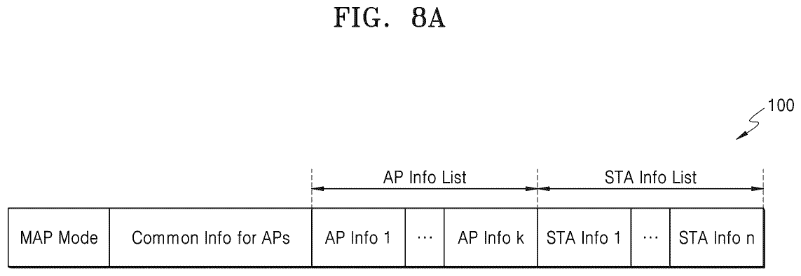

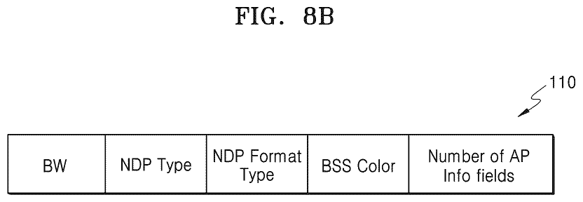

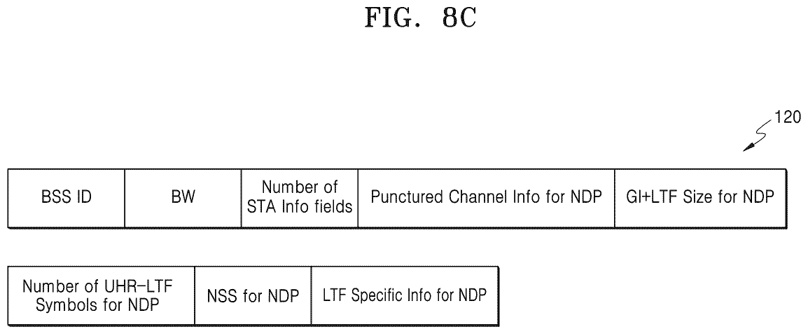

According to an embodiment, the first access point AP1 may transmit the MAP network frame to the second access point AP2 and the first to fourth stations STA1, STA2, STA3, and STA4 participating in MAP sounding, to start MAP sounding. The MAP network frame may include information that each of the second access point AP2 and the first to fourth stations STA1, STA2, STA3, and STA4 needs to know for MAP sounding. Each of the second access point AP2 and the first to fourth stations STA1, STA2, STA3, and STA4 may participate in MAP sounding based on the MAP network frame. A specific embodiment about a format of the MAP network frame will be described with reference to FIG. 8A.

Hereinafter, embodiments will be described based on the second access point AP2 which is a shared access point.

According to an embodiment, the second access point AP2 may identify the serial NDP transmission method and its own NDP transmission order from a MAP network frame received from the first access point AP1. Also, the second access point AP2 may generate a NDP based on NDP-related information included in the MAP network frame. As an example, the NDP-related information may include NDP common format information and NDP individual setting information. The second access point AP2 may determine a format of the NDP based on the NDP common format information, and generate the NDP that is identified to have been transmitted from the second access point AP2, based on the NDP individual setting information.

According to an embodiment, the second access point AP2 may transmit the NDP to the first to fourth stations STA1, STA2, STA3, and STA4 in association with NDP transmission by the first access point AP1, within a NDP transmission period based on the serial NDP transmission method. That is, the second access point AP2 may transmit the NDP to the first to fourth stations STA1, STA2, STA3, and STA4 at a transmission timing matching with the determined NDP transmission order such that a NDP transmission timing of the first access point AP1 and the NDP transmission timing of the second access point AP2 match with the determined NDP transmission order.

Hereinafter, embodiments will be described based on the first station STA1. The following embodiments may also be applied to the second to fourth stations STA2, STA3, and STA4.

According to an embodiment, the first station STA1 may obtain information about MAP sounding from a received MAP network frame. The information about MAP sounding may include at least one of information which the first station STA1 needs to receive NDPs transmitted from the first and second access points AP1 and AP2, information required to estimate a channel state using the NDPs, information required to generate MAP sounding feedbacks including channel state information, or information required to transmit the MAP sounding feedbacks to the first and second access points AP1 and AP2.

According to an embodiment, the first station STA1 may receive NDPs from the first and second access points AP1 and AP2 based on the information about MAP sounding. As a specific example, the first station STA1 may identify the serial NDP transmission method from the information about MAP sounding and predict (or estimate) reception timings of the NDPs based on the serial NDP transmission method, thereby accurately receiving the NDPs.

According to an embodiment, the first station STA1 may generate a first MAP sounding feedback to be transmitted to the first access point AP1 and a second MAP sounding feedback to be transmitted to the second access point AP2, based on the information about MAP sounding. More specifically, the first station STA1 may estimate a channel state between the first station STA1 and the first access point AP1 using a NPD received from the first access point AP1 to generate channel state information, and generate a first MAP sounding feedback including the channel state information. Also, the first station STA1 may estimate a channel state between the first station STA1 and the second access point AP2 using a NPD received from the second access point AP2, and generate a second MAP sounding feedback indicating the estimated channel state.

According to an embodiment, the first station STA1 may transmit the first MAP sounding feedback to the first access point AP1 in response to a first MAP trigger frame received from the first access point AP1, and transmit the second MAP sounding feedback to the second access point AP2 in response to a second MAP trigger frame received from the second access point AP2. In the first station STA1, a transmission timing of the first MAP sounding feedback may be different from a transmission timing of the second MAP sounding feedback.

In this way, the first and second access points AP1 and AP2 may receive MAP sounding feedbacks from the first to fourth stations STA1, STA2, STA3, and STA4, and may perform a ‘MAP interference improvement operation’ based on the received MAP sounding feedbacks.

In the wireless communication system 10 according to an embodiment, the first and second access points AP1 and AP2 in a MAP network may perform MAP sounding based on the serial NAP transmission method and a NDP transmission order to obtain feedbacks indicating channel states from the first to fourth stations STA1, STA2, STA3, and STA4 by efficiently using a RF resource. Also, a sharing AP (for example, AP1) may determine an optimal NDP transmission order for APs participating in MAP sounding and effectively inform the NDP transmission order to the APs participating in MAP sounding through a MAP network frame. Accordingly, the wireless communication system 10 may effectively perform a ‘MAP interference improvement operation’ by the serial NDP transmission method, thereby improving overall communication performance.

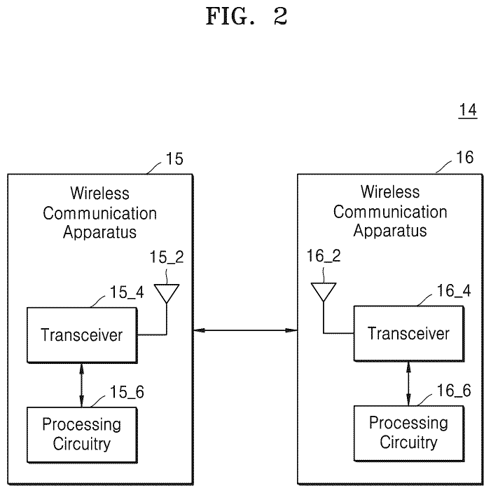

FIG. 2 is a block diagram showing a wireless communication system 14 according to an embodiment. More specifically, the block diagram of FIG. 2 shows a first wireless communication apparatus 15 and a second wireless communication apparatus 16 that communicate with each other in the wireless communication system 14. Each of the first wireless communication apparatus 15 and the second wireless communication apparatus 16 of FIG. 2 may be an apparatus for communication in the wireless communication system 14 and may be referred to as an apparatus for wireless communication. According to some embodiments, each of the first wireless communication apparatus 15 and the second wireless communication apparatus 16 may be an access point or station of a WLAN system.

Referring to FIG. 2, the first wireless communication apparatus 15 may include an antenna 15_2, a transceiver 15_4, or a processing circuit (or at least one processor) 15_6. According to some embodiments, the antenna 15_2, the transceiver 15_4, or the processing circuit 15_6 may be included in one package (or a processor) or respectively included in different packages (or multiple processors). The second wireless communication apparatus 16 may also include an antenna 16_2, a transceiver 16_4, and a processing circuit (or at least one processor) 16_6. Hereinafter, overlapping descriptions about the first wireless communication apparatus 15 and the second wireless communication apparatus 16 will be omitted.

The antenna 15_2 may receive a signal from the second wireless communication apparatus 16 and provide the signal to the transceiver 15_4, or may receive a signal provided from the transceiver 15_4 to the second wireless communication apparatus 16. According to some embodiments, the antenna 15_2 may include a plurality of antennas for multiple input multiple output (MIMO). Also, according to some embodiments, the antenna 15_2 may include a phased array for beamforming.

The transceiver 15_4 may process a signal received from the second wireless communication apparatus 16 through the antenna 15_2, and provide the processed signal to the processing circuit 15_6. Also, the transceiver 15_4 may process a signal provided from the processing circuit 15_6, and output the processed signal through the antenna 15_2. According to some embodiments, the transceiver 15_4 may include analog circuitries, such as a low noise amplifier, a mixer, a filter, a power amplifier, and an oscillator. According to some embodiments, the transceiver 15_4 may process a signal received from the antenna 15_2 and/or a signal received from the processing circuit 15_6 based on a control by the processing circuit 15_6.

The processing circuit 15_6 may extract information transmitted from the second wireless communication apparatus 16 by processing a signal received from the transceiver 15_4. For example, the processing circuit 15_6 may extract information from a signal received from the transceiver 15_4 by performing demodulation and/or decoding on the signal. Also, the processing circuit 15_6 may generate a signal including information that is to be transmitted to the second wireless communication apparatus 16 and provide the signal to the transceiver 15_4. For example, the processing circuit 15_6 may provide the transceiver 15_4 with a signal generated by performing encoding and/or demodulation on data that is to be transmitted to the second wireless communication apparatus 16. According to some embodiments, the processing circuit 15_6 may include a programmable component, such as central processing unit (CPU) and digital signal processor (DSP), a reconfigurable component such as field programmable gate array (FPGA), or a component with a fixed function such as intellectual property (IP) core. According to some embodiments, the processing circuit 15_6 may include a memory storing data and/or a series of instructions, or access the corresponding memory.

In the disclosure, a description that the transceiver 15_4 and/or the processing circuit 15_6 perform operations may be referred to as a description that the first wireless communication apparatus 15 performs the corresponding operations. Accordingly, operations that are performed by an access point may be performed by a transceiver and/or a processing circuit included in the access point, or operations that are performed by a station may be performed by a transceiver and/or a processing circuit in the station.

According to an embodiment, while the first wireless communication device 15 operates as a sharing access point, the first wireless communication device 15 may generate a MAP network frame for starting MAP sounding and transmit the MAP network frame to the second wireless communication device 16 operating as a shared access point or a shared station. According to an embodiment, the first wireless communication apparatus 15 may determine the serial NDP transmission method, determine a NDP transmission order of APs (for example, the first and second wireless communication apparatuses 15 and 16) participating in MAP sounding, and then, generate a MAP network frame indicating the NDP transmission order of the APs.

According to an embodiment, while the second wireless communication apparatus 16 operates as a shared access point, the second wireless communication apparatus 16 may participate in MAP sounding by transmitting NDPs to stations within a plurality of BSSs based on a MAP network frame received from the first wireless communication apparatus 15.

Accordingly, while the second wireless communication apparatus 16 operates as a station, the second wireless communication apparatus 16 may participate in MAP sounding by transmitting a MAP sounding feedback to the first wireless communication apparatus 15 based on a MAP network frame and a NDP received from the first wireless communication apparatus 15.

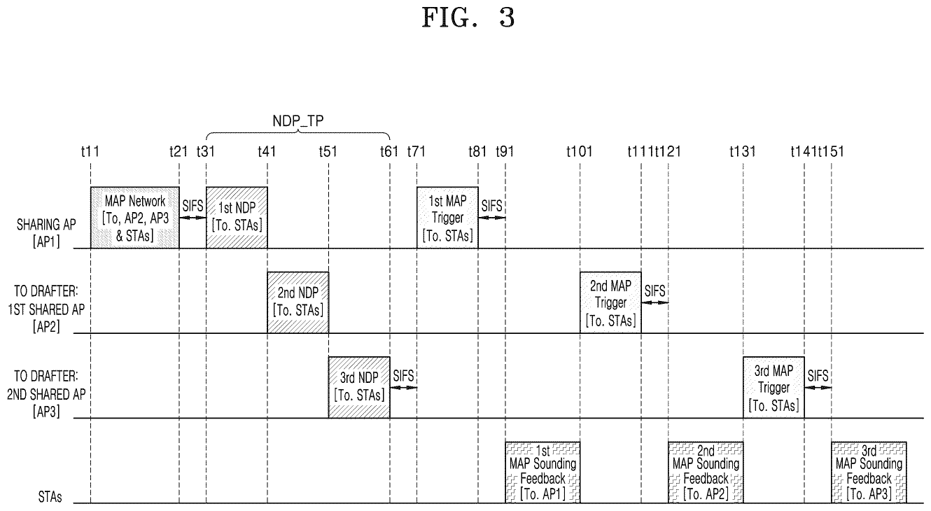

According to an embodiment, some components of the first and second wireless communication apparatuses 15 and 16 may be implemented, by software, such that operations for MAP sounding according to embodiments are performed on a medium access control (MAC) layer. According to an embodiment, some components of the first and second wireless communication apparatuses 15 and 16 may be implemented, by hardware, such that operations for MAP sounding according to embodiments are performed on a physical (PHY) layer. FIG. 3 is a timing diagram showing MAP sounding according to an embodiment.

In FIG. 3, a first access point AP1 is a sharing AP, second and third access points AP2 and AP3 are shared APs, and the first to third access points AP1, AP2, and AP3 and stations STAs participate in MAP sounding. The second access point AP2 may be referred to as a first shared AP, and the third access point AP3 may be referred to as a second shared AP. However, FIG. 3 shows an embodiment, and the disclosure is not limited to this. The aspects of the disclosure may also be applied to a MAP network including more shared APs.

Referring to FIG. 3, at time t11, the first access point AP1 may transmit a MAP network frame to the second and third access points AP2 and AP3 and the stations STAs. For example, the first access point AP1 may determine the serial NDP transmission method, determine a NDP transmission order which is an order of the first access point AP1, the second access point AP2, and the third access point AP3, and generate a MAP network frame indicating the determined results. Each of the second and third access points AP2 and AP3 and the stations STAs may obtain information required for MAP sounding from the MAP network frame, and prepare MAP sounding based on the obtained information. For example, each of the second and third access points AP2 and AP3 may prepare MAP sounding by identifying the serial NDP transmission method and its own NDP transmission order from the MAP network frame. More specifically, the second access point AP2 may prepare MAP sounding by identifying that its own NDP transmission order is second from the MAP network frame. Also, the third access point AP3 may prepare MAP sounding by identifying that its own NDP transmission order is third from the MAP network frame.

At time t31 after a ‘short interframe space’ (SIFS) has elapsed from the time t21, the first access point AP1 may transmit a first NDP in first to the stations STAs according to the determined NDP transmission order.

At time t41, the second access point AP2 may transmit a second NDP in second to the stations STAs based on the serial NDP transmission method and the NDP transmission order identified from the MAP network frame, after the first access point AP1 transmits the first NDP to the stations STAs.

At time t51, the third access point AP3 may transmit a third NDP in third to the stations STAs based on the serial NDP transmission method and the NDP transmission order identified from the MAP network frame, after the second access point AP2 transmits the second NDP to the stations STAs.

More specifically, in a NDP transmission period NDP_TP from the time t31 to the time t61, the first to third access points AP1, AP2, and AP3 may transmit the first to third NDPs serially to the stations STAs. FIG. 3 shows a case in which transmission of the first NDP does not overlap with transmission of the second NDP and transmission of the second NDP does not overlap with transmission of the third NDP in time. However, the disclosure is not limited to this. In some embodiments, an end part of transmission of the first NDP may overlap with a beginning part of transmission of the second NDP or an end part of transmission of the second NDP may overlap with a beginning part of transmission of the third NDP in time. Also, in some embodiments, an end part of transmission of the first NDP may be spaced a preset time or SIFS from a beginning part of transmission of the second NDP, and an end part of transmission of the second NDP may be spaced a preset time or SIFS from a beginning part of transmission of the third NDP.

The stations STAs may identify the first to third NDPs based on information obtained from the MAP network frame. Each of the stations STAs may estimate a first channel state between itself and the first access point AP1 by using the first NDP to generate first channel state information. Each of the stations STAs may estimate a second channel state between itself and the second access point AP2 by using the second NDP to generate second channel state information. Also, each of the stations STAs may estimate a third channel state between itself and the third access point AP3 by using the third NDP to generate third channel state information.

At time t71 after a SIFS has elapsed from the time t61, the first access point AP1 may transmit a first MAP trigger frame to the stations STAs. For example, the first MAP trigger frame may correspond to a beamforming report poll (BFRP) trigger frame.

At time t91 after a SIFS has elapsed from the time t81, each of the stations STAs may transmit a first MAP sounding feedback including the first channel state information to the first access point AP1 in response to the first MAP trigger frame.

At time t101, the second access point AP2 may transmit a second MAP trigger frame to the stations STAs. For example, the second MAP trigger frame may correspond to a BFRP trigger frame.

At time t121 after a SIFS has elapsed from the time t111, each of the stations STAs may transmit a second MAP sounding feedback including the second channel state information to the second access point AP2 in response to the second MAP trigger frame.

At time t131, the third access point AP3 may transmit a third MAP trigger frame to the stations STAs. For example, the third MAP trigger frame may correspond to a BFRP trigger frame.

At time t151 after a SIFS has elapsed from the time t141, each of the stations STAs may transmit a third MAP sounding feedback including the third channel state information to the third access point AP3 in response to the third MAP trigger frame.

According to an embodiment, as shown in FIG. 3, a transmission order in which the first to third MAP trigger frames are transmitted may match with a transmission order in which the first to third NDPs are transmitted.

The third to third access points AP1, AP2, and AP3 may perform a ‘MAP interference improvement operation’ based on the first to third MAP sounding feedbacks received from the stations STAs.

FIGS. 4A and 4B illustrate a ‘MAP interference improvement operation’ performed based on channel state information collected through MAP sounding according to an embodiment. Hereinafter, descriptions overlapping with those described above with reference to FIG. 1 will be omitted.

FIG. 4A shows a coordinated beamforming operation of the first access point AP1. Referring to FIG. 4A, the first access point AP1 may generate beamformed data ‘DATA’ based on MAP sounding feedbacks received through MAP sounding from the first and second stations STA1 and STA2 within the first BSS 11, and transmit the beamformed data DATA to the first and second stations STA1 and STA2. Also, the first access point AP1 may perform ‘null steering’ based on MAP sounding feedbacks received through MAP sounding from the third and fourth stations STA3 and STA3 within the second BSS 12. In the embodiment, ‘null steering’ may be defined as an operation of coordinating a beamforming matrix of a signal to be transmitted from the first access point AP1 such that the signal does not interfere with a communication between the second access point AP2 and the third and fourth stations STA3 and STA4. For example, a signal transmitted based on ‘null steering’ may be measured as received power close to 0 at the third station STA3 after passing through a channel between the first access point AP1 and the third station STA3.

In FIG. 4B, a joint transmission operation between the first and second access points AP1 and AP2 is shown. Referring to FIG. 4B, the first and second access points AP1 and AP2 may perform ‘backhaul data sharing’ to share data that is to be transmitted to the first and third stations STA1 and STA3. The first and second access points AP1 and AP2 may perform a joint transmission operation by cooperating with each other based on a MAP sounding feedback received through MAP sounding from the first station STA1 within the first BSS 11. Also, the first and second access points AP1 and AP2 may perform a joint transmission operation by cooperating with each other based on a MAP sounding feedback received through MAP sounding from the third station STA3 within the second BSS 12.

However, FIGS. 4A and 4B are only examples of the ‘MAP interference improvement operation.’ The disclosure is not limited to these. The ‘MAP interference improvement operation’ may include more examples, and MAP sounding according to embodiments may be applied to various examples.

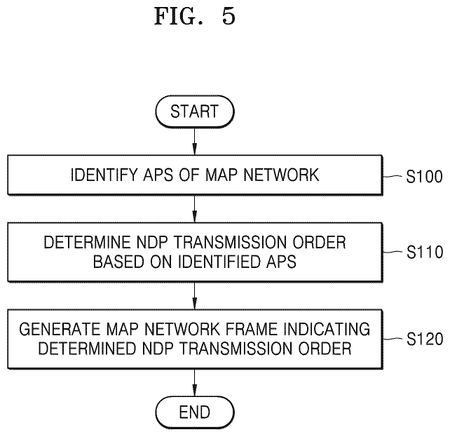

FIG. 5 is a flowchart illustrating a method of determining a NDP transmission order in a sharing AP, according to an embodiment.

Referring to FIG. 5, in operation S100, the sharing AP may identify APs of a MAP network. According to an embodiment, the sharing AP may identify APs determined to participate in MAP sounding in the MAP network.

In operation S110, the sharing AP may determine a NDP transmission order based on the APs identified in operation S100. The identified APs may include the sharing AP and at least one shared AP. According to an embodiment, the sharing AP may randomly determine a NDP transmission order of the identified APs. According to an embodiment, the sharing AP may preferentially determine a NDP transmission order of the sharing AP and then determine a NDP transmission order of the remaining shared AP. According to some embodiments, the NDP transmission order of the sharing AP may be a fixed order that may be promised in the MAP network. According to an embodiment, the sharing AP may determine a NDP transmission order of the identified APs based on a history related to a NDP transmission order previously determined for NDP sounding. However, this is only an embodiment. The disclosure is not limited to this, and the sharing AP may determine a NDP transmission order of the identified APs based on various factors related to the MAP network.

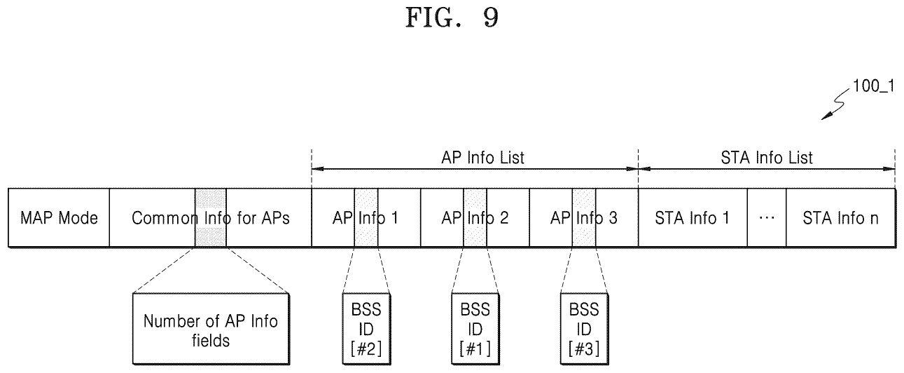

In operation S120, the sharing AP may generate a MAP network frame indicating the NDP transmission order determined in operation S110. According to an embodiment, the MAP network frame may include a plurality of AP information fields arranged to match with the determined NDP transmission order. According to an embodiment, the MAP network frame may include a plurality of AP information fields each including a preset subfield indicating a determined NDP transmission order. Details about this operation will be described with reference to FIGS. 9 to 11, below.

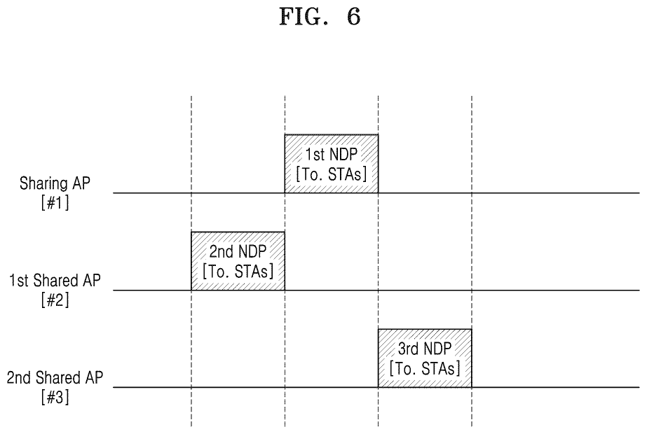

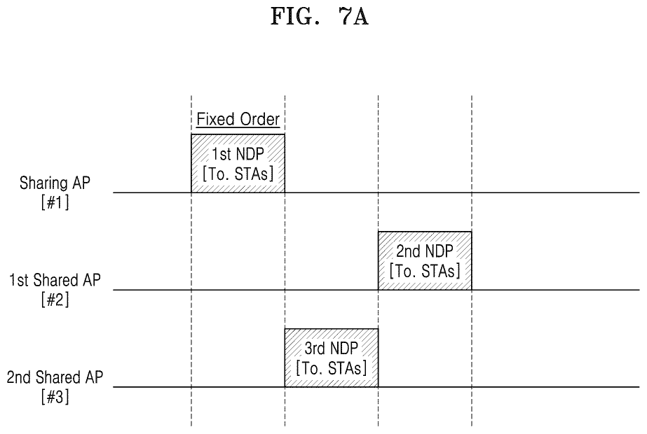

FIG. 6 illustrates a method of determining a NDP transmission order in a sharing AP, according to an embodiment. ‘#1’, ‘#2’, and ‘#3’ may be BSS ID values (or BSS index values) respectively indicating a sharing AP and first and second shared APs.

Referring to FIG. 6, the sharing AP #1 may identify the sharing AP #1 and the first and second shared APs #2 and #3 participating in MAP sounding in a MAP network, and randomly determine a NDP transmission order of the identified APs #1, #2, and #3.

According to some embodiments, by using at least one of various random determining methods, the sharing AP #1 may determine the NDP transmission order of the sharing AP #1 and the first and second shared APs #2 and #3 participating in MAP sounding.

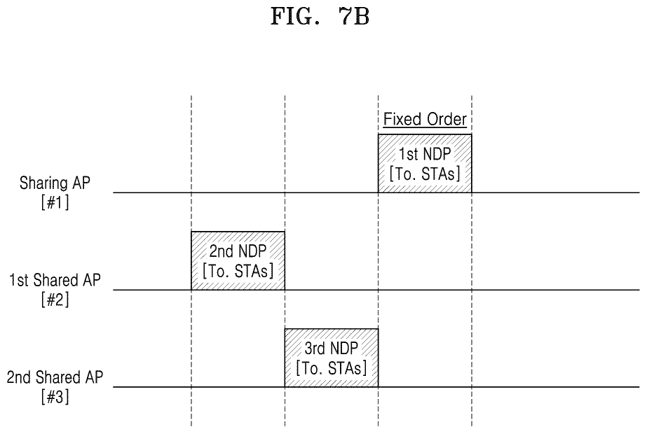

In FIG. 6, first to third NDPs are shown to be transmitted successively in time. However, embodiments are not limited to this, and the first to third NDPs may be spaced by a preset time or SIFS from each other. As a specific example, an end part of transmission of the second NDP may be spaced by a preset time or SIFS from a beginning part of transmission of the first NDP and an end part of transmission of the first NDP may be spaced by a preset time or SIFS from a beginning part of transmission of the third NDP. The embodiment may also be applied to FIGS. 7A and 7B.

FIGS. 7A and 7B illustrate a method of determining a NDP transmission order in a sharing AP, according to an embodiment. ‘#1’, ‘#2’, and ‘#3’ may be BSS ID values (or BSS index values) respectively indicating a sharing AP and first and second shared APs.

Referring to FIG. 7A, the sharing AP #1 may identify the sharing AP #1 and first and second shared APs #2 and #3 participating in MAP sounding in a MAP network, and determine a NDP transmission order of the identified APs #1, #2, and #3 based on a fixed NDP transmission order of the sharing AP #1. As a specific example, a NDP transmission order of the sharing AP #1 may be fixed to first, which may have been promised in advance in the MAP network. Accordingly, the sharing AP #1 may randomly determine a NDP transmission order of the first and second shared APs #2 and #3 by considering the NDP transmission order of the sharing AP #1. More specifically, the sharing AP #1 may determine a NDP transmission order such that the sharing AP #1 transmits a first NDP in first to stations STAs, the second shared AP #3 transmits a third NDP in second to the stations STAs, and the first shared AP #2 transmits a second NDP in third to the stations STAs.

Referring to FIG. 7B, a NDP transmission order of the sharing AP #1 may be fixed to third that is final, which may have been promised in advance in the MAP network. Accordingly, the sharing AP #1 may randomly determine NDP transmission orders of the first and second shared APs #2 and #3 by considering the NDP transmission order of the sharing AP #1. More specifically, the sharing AP #1 may determine NDP transmission orders such that the first shared AP #2 transmits a second NDP in first to the stations STAs, the second shared AP #3 transmits a third NDP in second to the stations STAs, and the sharing AP #1 transmits a first NDP in third to the stations STAs. In some embodiments, the number of APs participating in MAP sounding may be L, and in this case, a NDP transmission order of the sharing AP #1 may be L-th that is final.

However, the embodiments shown in FIGS. 7A and 7B are only examples, and the disclosure is not limited to these. A NDP transmission order of a sharing AP or at least one shared AP may be fixed to various orders, and the sharing AP may determine a NDP transmission order of APs participating in MAP sounding based on a fixed order.

FIG. 8A shows a MAP network frame 100 according to an embodiment. FIG. 8B shows a common information field 110 of FIG. 8A. FIG. 8C shows an AP information field 120 of FIG. 8A.

Referring to FIG. 8A, the MAP network frame 100 may include a MAP mode field (‘MAP Mode’), a common information field for APs (‘Common Info for APs’), a plurality of AP information fields (‘AP Info 1’ to ‘AP Info k’), and a plurality of STA information fields (‘STA Info 1’ to ‘STA Info n’). The plurality of AP information fields (‘AP Info 1’ to ‘AP Info k’) may include first to k-th (k is an integer of 1 or more) AP information fields, and the plurality of STA information fields (‘STA Info 1’ to ‘STA Info n’) may include first to n-th (n is an integer than 2 or more) STA information fields. The number of the plurality of AP information fields (‘AP Info 1’ to ‘AP Info k’) may match with the number of APs participating in MAP sounding, and the number of the plurality of STA information fields (‘STA Info 1’ to ‘STA Info n’) may match with the number of STAs participating in MAP sounding. In the disclosure, the plurality of AP information fields (‘AP Info 1’ to ‘AP Info k’) may also be referred to as an AP information list (‘AP Info List’), and the plurality of STA information fields (‘STA Info 1’ to ‘STA Info n’) may be referred to as a STA information list (‘STA Info List’).

According to an embodiment, a MAP mode field (‘MAP Mode’) may be a field indicating a MAP mode in which the MAP network frame 100 operates. For example, MAP modes may include a coordinated-spatial reuse (c-SR) mode, a coordinated-orthogonal frequency division multiplexing (c-OFDMA) mode, a coordinated-beamforming mode (or a coordinated beamforming mode), a joint transmission mode, and a MAP sounding mode. More specifically, a sharing AP may set a value indicating a MAP sounding mode in the MAP mode field (‘MAP Mode’) to inform APs and STAs participating in MAP sounding.

According to an embodiment, the common information field (‘Common Info for APs’) may include information required in common for the APs to perform MAP sounding. For example, the corresponding information may include information required for the APs to generate NDPs and transmit the NDPs. More specifically, the common information field (‘Common Info for APs’) may include information about the number of the APs participating in MAP sounding. A specific example of the common information field (‘Common Info for APs’) will be described with reference to FIG. 8B, below.

According to an embodiment, the AP information field (‘AP Info 1’ to ‘AP Info k’) may include information required for an AP having a specific BSS ID to generate a NDP and transmit the NDP. For example, the corresponding information may include information to enable STAs to identify a NDP transmitted from a specific AP. For example, an arrangement order of the plurality of AP information fields (‘AP Info 1’ to ‘AP Info k’) may indicate a NDP transmission order of APs participating in MAP sounding. As another example, the AP information field (‘AP Info 1’ to ‘AP Info k’) may further include information indicating a NDP transmission order of an AP having a specific BSS ID. A specific embodiment of the AP information field (‘AP Info 1’ to ‘AP Info k’) will be described with reference to FIG. 8C, below.

According to an embodiment, the STA information field (‘STA Info 1’ to ‘STA Info n’) may include information required for a STA having a specific STA ID to estimate channel states by using NDPs received from APs.

According to an embodiment, a shared AP may identify the MAP sounding mode based on a value of the MAP mode field (‘MAP Mode’) of the MAP network frame 100, identify a NDP transmission method based on the common information field (‘Common Info for APs’) of the MAP network frame 100, and transmit a NDP to STAs based on the identified NDP transmission method. More specifically, the shared AP may identify the serial transmission method from the common information field (‘Common Info for APs’), and identify its own transmission order based on at least one of the plurality of AP information fields (‘AP Info 1’ to ‘AP Info k’).

However, the MAP network frame 100 of FIG. 8A is only an embodiment, and the disclosure is not limited to this. The arrangement order of the fields of the MAP network frame 100 may change variously, and the MAP network frame 100 may further include fields required for MAP sounding.

The sharing AP may generate information required for the at least one shared AP and STAs for MAP sounding, appropriately arrange the generated information in fields of the MAP network frame 100, and then transmit the MAP network frame 100 to the at least one shared AP and STAs.

Referring further to FIG. 8B, the common information field 110 may include a bandwidth subfield (‘BW’), a NDP type subfield (‘NDP Type’), a NDP format type subfield (‘NDP Format Type’), a BSS color subfield (‘BSS Color’), and an number-of-AP information subfield (‘Number of AP Info fields’).

According to an embodiment, the bandwidth subfield (‘BW’) may indicate a bandwidth of NDPs transmitted from APs. According to some embodiments, while APs transmits NDPs with different bandwidths, the bandwidth subfield (‘BW’) may be omitted from the common information field 110, and each of the AP information fields (‘AP Info 1’ to ‘AP Info k’) may include a bandwidth subfield (‘BW’).

According to an embodiment, the NDP type subfield (‘NDP Type’) may indicate a NDP transmission method. For example, the NDP type subfield (‘NDP Type’) may indicate any one of the serial NDP transmission method or the joint NDP transmission method.

According to an embodiment, the NDP format type subfield (‘NDP Format Type’) may indicate a type of a protocol data unit (‘PPDU’) format of a NDP. For example, the NDP format type subfield (‘NDP Format Type’) may indicate any one of a type of a format matching with UHR sounding or an amendment type of a format matching with next-generation sounding of UHR.

According to an embodiment, the BSS color subfield (‘BSS Color’) may indicate a value that needs to be set in a BSS color field in a preamble of a NDP in the case in which the NDP transmission method is the joint NDP transmission method.

According to an embodiment, the number-of-AP information subfield (‘Number of AP Info fields’) may indicate the number of APs (including a sharing AP and at least one shared AP) participating in MAP sounding. For example, a value of the number-of-AP information subfield (‘Number of AP Info fields’) may indicate the number of the AP information fields (‘AP Info 1’ to ‘AP Info’) in the AP information list (‘AP Info List’). For example, the shared AP may identify the number of APs participating in MAP sounding from the number-of-AP information subfield (‘Number of AP Info fields’) to determine a NDP transmission period, and transmit a NDP at a transmission timing matching with its own NDP transmission order within the determined NDP transmission period.

However, the common information field 110 shown in FIG. 8B is only an embodiment, and the disclosure is not limited to this. The arrangement order of the subfields in the common information field 110 may change variously, and the common information field 110 may further include subfields required in common for MAP sounding.

Referring further to FIG. 8C, the AP information field 120 may include a BSS ID subfield (‘BSS ID’), a bandwidth subfield (‘BW’), a number-of-STA information subfield (“Number of STA Info fields), a punctured channel information subfield for NPD (‘Punctured Channel Info for NDP’), a guard interval (GI)+long training field (LTE) size subfield for NDP (‘GI+LTF Size for NDP’), a number-of-UHR-LTF symbols subfield (‘Number of UHR-LTF Symbols for NDP’), a number-of-spatial stream (NSS) subfield for NDP (‘NSS for NDP’), and a LTF specific information subfield for LDP (‘LTF Specific Info for NDP’).

According to an embodiment, the BSS ID subfield (‘BSS ID’) may be a subfield to enable an AP having a value of the BSS ID subfield as a BSS ID among APs participating in MAP sounding to identify the corresponding AP information field 120. That is, an AP may identify the AP information field 120 assigned to the AP through the BSS ID subfield (‘BSS ID’). According to some embodiments, the BSS ID subfield (‘BSS ID’) may be replaced with a MAP ID subfield. For example, the MAP ID subfield may include an ID newly assigned to identify the corresponding AP through MAP sounding signaling performed in advance for MAP sounding (or MAP communication). However, this is only an embodiment, and the disclosure is not limited to this. To enable APs participating in MAP sounding to identify their own AP information fields 120, the BSS ID subfield (BSS ID) may be implemented variously.

According to an embodiment, the bandwidth subfield (‘BW’) may indicate a bandwidth of a NDP transmitted from the AP having the value of the BSS ID subfield (‘BSS ID’) as a BSS ID. According to some embodiments, in the case in which NDPs transmitted from APs have the same bandwidth, the bandwidth subfield BW may be omitted from the AP information field 120, and the bandwidth subfield BW may be positioned in the common information field 110 of FIG. 8B.

According to an embodiment, the number-of-STA information subfield (‘Number of STA Info fields’) may indicate the number of STAs participating in MAP sounding among STAs related to the AP having the value of the BSS ID subfield (‘BSS ID’) as a BSS ID. The STAs related to the AP may be understood as STAs within a BSS of the corresponding AP.

According to an embodiment, the punctured channel information subfield (‘Punctured Channel Info for NDP’) may indicate punctured information of a NDP transmitted from the AP having the value of the BSS ID subfield (‘BSS ID’) as a BSS ID.

According to an embodiment, the GI+LTF size subfield (‘GI+LTF Size for NDP’) may indicate a GI duration and a UHR-LTF size of a NDP transmitted from the AP having the value of the BSS ID subfield (‘BSS ID’) as a BSS ID.

According to an embodiment, the number-of-UHR-LTF symbols subfield (‘Number of UHR-LTF Symbols for NDP’) may indicate the number of UHR-LTF symbols of a NDP transmitted from the AP having the value of the BSS ID subfield (‘BSS ID’) as a BSS ID.

According to an embodiment, the NSS subfield (‘NSS for NDP’) may indicate the number of spatial streams of a NDP transmitted from the AP having the value of the BSS ID subfield (‘BSS ID’) as a BSS ID.

According to an embodiment, the LTF specific information subfield (‘LTF Specific Info for NDP’) may indicate specific information required to generate a NDP in the AP having the value of the BSS ID subfield (‘BSS ID’) as a BSS ID. According to an embodiment, the specific information may indicate a NDP transmission order of the corresponding AP in the serial NDP transmission method. According to some embodiments, the LTE specific information subfield (‘LTF Specific Info for NDP’) may not indicate a NDP transmission order of the corresponding AP, and the NDP transmission order of the corresponding AP may be replaced with the arrangement order of the plurality of AP information fields (‘AP Info 1’ to ‘AP Info k’) of FIG. 8A.

In the disclosure, the punctured channel information subfield (‘Punctured Channel Info for NDP’), the GI+LTF size subfield (‘GI+LTF Size for NDP’), the number-of-UHR-LTF symbols subfield (‘Number of UHR-LTF Symbols for NDP’), and the NSS subfield (‘NSS for NDP’) may be defined as concepts included in individual settings or individual setting information for generating a NDP in the AP having the value of the BSS ID subfield (‘BSS ID’) as a BSS ID.

However, the AP information field 120 of FIG. 8C is only an embodiment, and the disclosure is not limited to this. The arrangement order of the subfields of the AP information field 120 may change variously, and the AP information field 120 may further include subfields respectively required for APs for MAP sounding.

FIG. 9 is a diagram specifically showing a MAP network frame 100_1 indicating a NDP transmission order, according to an embodiment. FIG. 9 shows an example of the MAP network frame 100_1 including information about a NDP transmission order for a sharing AP to inform shared APs of the NDP transmission order. The following descriptions will be given with respect to the embodiment of FIG. 6. That is, a sharing AP #1 and first and second shared APs #2 and #3 may participate in MAP sounding, and a NDP transmission order may be an order of the first shared AP #2, the sharing AP #1, and the second shared AP #3.

Referring to FIG. 9, a common information field (‘Common Info for APs’) of the MAP network frame 100_1 may indicate a number-of-AP information subfield (‘Number of AP Info fields’), and the number-of-AP information subfield (‘Number of AP Info fields’) may indicate the number of APs (for example, the sharing AP #1 and the first and second shard APs #2 and #3) participating in MAP sounding.

According to an embodiment, first to third AP information fields (‘AP Info 1,’ ‘AP Info 2,’ and ‘AP Info 3’) may be positioned based on the NDP transmission order on the MAP network frame 100_1. For example, a first AP information field (‘AP Info 1’) may be assigned to the first shared AP #2 to store a value of ‘#2’ in a BSS ID subfield (‘BSS ID’) of the first AP information field (‘AP Info 1’), a second AP information field (‘AP Info 2’) may be assigned to the sharing AP #1 to store a value of ‘#1’ in a BSS ID subfield (‘BSS ID’) of the second AP information field (‘AP Info 2’), and a third AP information field (‘AP Info 3’) may be assigned to the second shared AP #3 to store a value of ‘#3’ in a BSS ID subfield (‘BSS ID’) of the third AP information field (‘AP Info 3’).

According to an embodiment, the first shared AP #2 may identify the number of APs participating in MAP sounding by referring to the number-of-AP information subfield (‘Number of AP Info fields’) of the common information field (‘Common Info for APs’) of the MAP network frame 100_1. Then, the first shared AP #2 may confirm that its own NDP transmission order is first, based on an arrangement order of the first AP information field (‘AP Info 1’) assigned thereto. The first shared AP #2 may determine a NDP transmission period based on the number of APs participating in MAP sounding, and transmit a second NDP to stations at a transmission timing matching with the first NDP transmission order within the determined NDP transmission period. In this way, the second shared AP #3 may also identify its own NDP transmission order, and detailed descriptions thereof will be omitted.

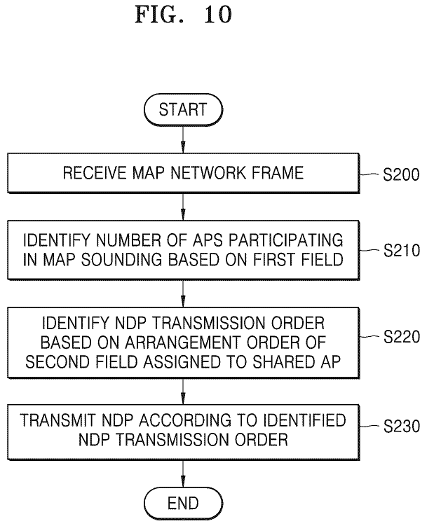

FIG. 10 is a flowchart for describing an operation method of a shared AP, according to an embodiment.

Referring to FIG. 10, in operation S200, a shared AP may receive a MAP network frame from a sharing AP.

In operation S210, the shared AP may identify the number of APs participating in MAP sounding based on a first field of the MAP network frame. According to an embodiment, the shared AP may determine a NDP transmission period based on the number of APs.

In operation S220, the shared AP may identify a NDP transmission order of the shared AP based on an arrangement order of a second field assigned to the shared AP in the MAP network frame.

In operation S230, the shared AP may transmit a NDP to stations participating in MAP sounding according to the NDP transmission order identified in operation S220. According to an embodiment, the shared AP may transmit the NDP to the stations at a transmission timing matching with its own NDP transmission order within the determined NDP transmission period.

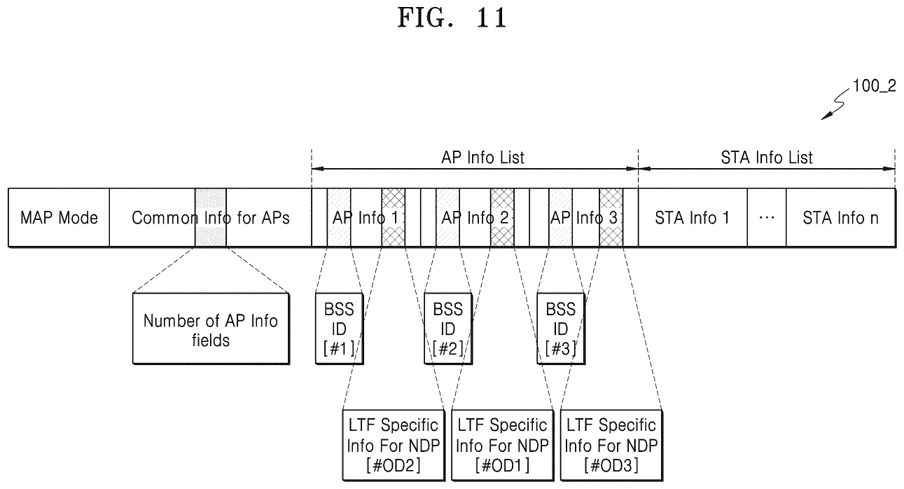

FIG. 11 is a diagram specifically showing a MAP network frame 100_2 indicating a NDP transmission order, according to an embodiment. FIG. 11 shows an example of the MAP network frame 100_2 including information about a NDP transmission order for a sharing AP to inform shared APs of the NDP transmission order. The following descriptions will be given with respect to the embodiment of FIG. 6. That is, a sharing AP #1 and first and second shared APs #2 and #3 may participate in MAP sounding, and a NDP transmission order may be an order of the first shared AP #2, the sharing AP #1, and the second shared AP #3.

Referring to FIG. 11, a common information field (‘Common Info for APs’) of the MAP network frame 100_2 may include a number-of-AP information subfield (‘Number of AP Info fields’), and the number-of-AP information subfield (‘Number of AP Info fields’) may indicate the number of APs (for example, the sharing AP #1 and the first and second shared APs #2 and #3) participating in MAP sounding.

According to an embodiment, first to third AP information fields (‘AP Info 1,’ ‘AP Info 2,’ and ‘AP Info 3’) may be positioned in an ascending order of BSS IDs on the MAP network frame 100_2. However, this is only an embodiment, and the disclosure is not limited to this. The first to third AP information fields (‘AP Info 1,’ ‘AP Info 2,’ and ‘AP Info 3’) may be positioned variously.

For example, the first AP information field (‘AP Info 1’) may be assigned to the sharing AP #1 to store a value of ‘#1’ in a BSS ID subfield (‘BSS ID’) of the first AP information field (‘AP Info 1’), and store a value of ‘#OD2’ indicating a second NDP transmission order in a LTF specific information subfield (‘LTF Specific Info for NDP’) of the first AP information field (‘AP Info 1’). The second AP information field (‘AP Info 2’) may be assigned to the first shared AP #2 to store a value of ‘#2’ in a BSS ID subfield (‘BSS ID’) of the second AP information field (‘AP Info 2’), and store a value of ‘#OD1’ indicating a first NDP transmission order in a LTF specific information subfield (‘LTF Specific Info for NDP’) of the second AP information field (‘AP Info 2’). Also, the third AP information field (‘AP Info 3’) may be assigned to the second shared AP #3 to store a value of ‘#3’ in a BSS ID subfield (‘BSS ID’) of the third AP information field (‘AP Info 3’), and store a value of ‘#OD3’ indicating a third NDP transmission order in a LTF specific information subfield (‘LTF Specific Info for NDP’) of the third AP information field (‘AP Info 3’).

According to an embodiment, the first shared AP #2 may identify the number of APs participating in MAP sounding by referring to the number-of-AP information subfield (‘Number of AP Info fields’) of the common information field (‘Common Info for APs’) of the MAP network frame 100_2. Thereafter, the first shared AP #2 may confirm that its own NDP transmission order is first, based on the value of ‘#OD1’ stored in the LTF specific information subfield (‘LTF Specific Info for NDP’) of the second AP information field (‘AP Info 2’) assigned thereto. The first shared AP #2 may determine a NDP transmission period based on the number of APs participating in MAP sounding, and transmit a second NDP to the stations at a transmission timing matching with the first NDP transmission order within the determined NDP transmission period. In this way, the second shared AP #3 may also identify its own NDP transmission order, and detailed descriptions thereof will be omitted.

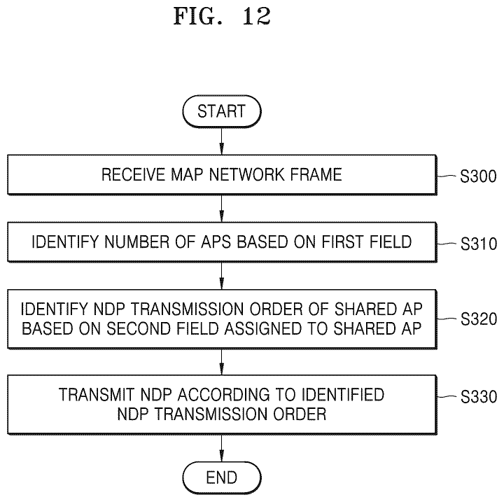

FIG. 12 is a flowchart for describing an operation method of a shared AP, according to an embodiment.

Referring to FIG. 12, in operation S300, the shared AP may receive a MAP network frame from a sharing AP.

In operation S310, the shared AP may identify the number of APs participating in MAP sounding based on a first field of the MAP network frame. According to an embodiment, the shared AP may determine a NDP transmission time based on the number of APs.

In operation S320, the shared AP may identify a NDP transmission order of the shared AP based on a second field assigned to the shared AP in the MAP network frame. According to an embodiment, the shared AP may extract a value of a specific subfield of the second field assigned thereto to identify its own NDP transmission order based on the extracted value.

In operation S330, the shared AP may transmit a NDP to stations participating in MAP sounding according to the NDP transmission order identified in operation S320. According to an embodiment, the shared AP may transmit the NDP at a transmission timing matching with its own NDP transmission order within the determined NDP transmission period.

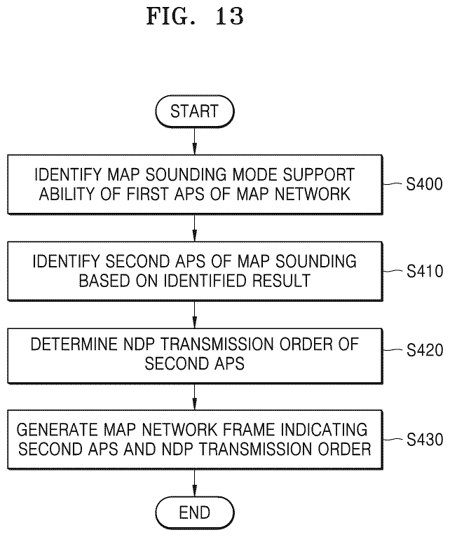

FIG. 13 is a flowchart for describing an operation method of a sharing AP, according to an embodiment.

Referring to FIG. 13, in operation S400, a sharing AP may identify MAP sounding mode support ability of first APs of a MAP network. More specifically, the sharing AP may receive information indicating the MAP sounding mode support ability from the first APs, and identify MAP sounding mode support ability of each of the first APs based on the received information.

In operation S410, the sharing AP may identify second APs (or second APs participating in MAP sounding) of MAP sounding based on the result identified in operation S400.

In operation S420, the sharing AP may determine a NDP transmission order of the second APs identified in operation S410.

In operation S430, the sharing AP may generate a MAP network frame indicating the second APs and the NDP transmission order. The MAP network frame may indicate a NDP transmission method of the second APs participating in MAP sounding according to the above-described embodiments.

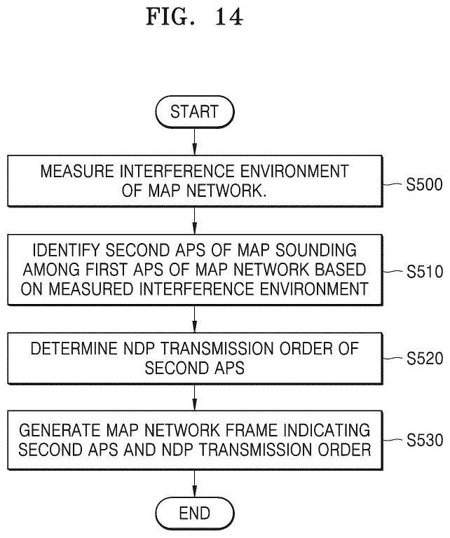

FIG. 14 is a flowchart for describing an operation method of a sharing AP, according to an embodiment.

Referring to FIG. 14, in operation S500, the sharing AP may measure an interference environment of a MAP network. More specifically, the sharing AP may measure an interference environment of a MAP network by measuring a degree of interference between APs in the MAP network.

In operation S510, the sharing AP may identify second APs (or second APs participating in MAP sounding) of MAP sounding among first APs of the MAP network based on the interference environment measured in operation S500. More specifically, the sharing AP may determine the second APs having a degree of interference of a reference value or more among the first APs to APs participating in MAP sounding, based on the measured interference environment.

In operation S520, the sharing AP may determine a NDP transmission order of the second APs identified in operation S510.

In operation S530, the sharing AP may generate a MAP network frame indicating the second APs and the NDP transmission order. The MAP network frame may indicate a NDP transmission method of the second APs participating in MAP sounding according to the above-described embodiments.

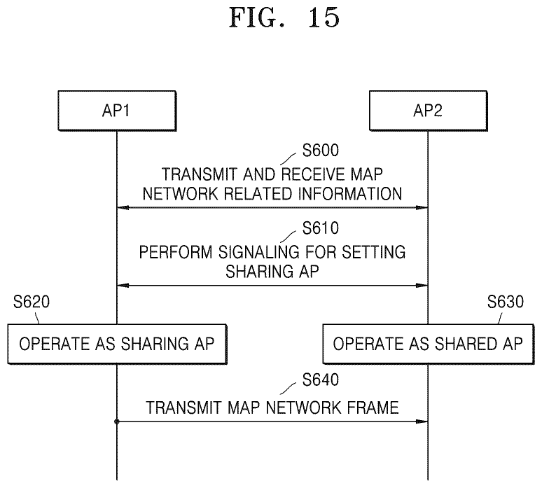

FIG. 15 is a flowchart illustrating an operation method in a MAP network, according to an embodiment. In an embodiment, the MAP network includes first and second access points AP1 and AP2.

Referring to FIG. 15, in operation S600, the first and second access points AP 1 and AP2 may transmit and receive MAP network related information.

In operation S610, the first and second access points AP1 and AP2 may perform a signaling for determining a sharing AP.

In operation S620, the first access point AP1 may operate as a sharing AP, and in operation S630, the second access point AP2 may operate as a shared AP.

In operation S640, the first access point AP1 may transmit a MAP network frame to the second access point AP2. The MAP network frame may include information indicating the serial transmission method for MAP sounding and a NDP transmission order of the second access point AP2, according to the above-described embodiments.

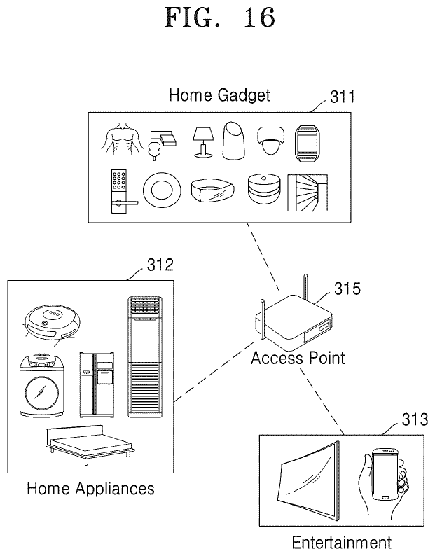

FIG. 16 shows examples of apparatuses for wireless communication according to an embodiment. More specifically, FIG. 16 shows an Internet of Things (IoT) network system including home gadgets 311, home appliances 312, entertainment devices 313, and an access point 315.

Apparatuses for wireless communication in FIG. 16 may prepare MAP sounding by transmitting and receiving a MAP network frame, as described above with reference to FIGS. 1 to 15. Also, the apparatuses for wireless communication in FIG. 16 may perform MAP sounding based on a NDP transmission method indicated by the MAP network frame. Thereby, overall communication throughput of the apparatuses for wireless communication may be improved.

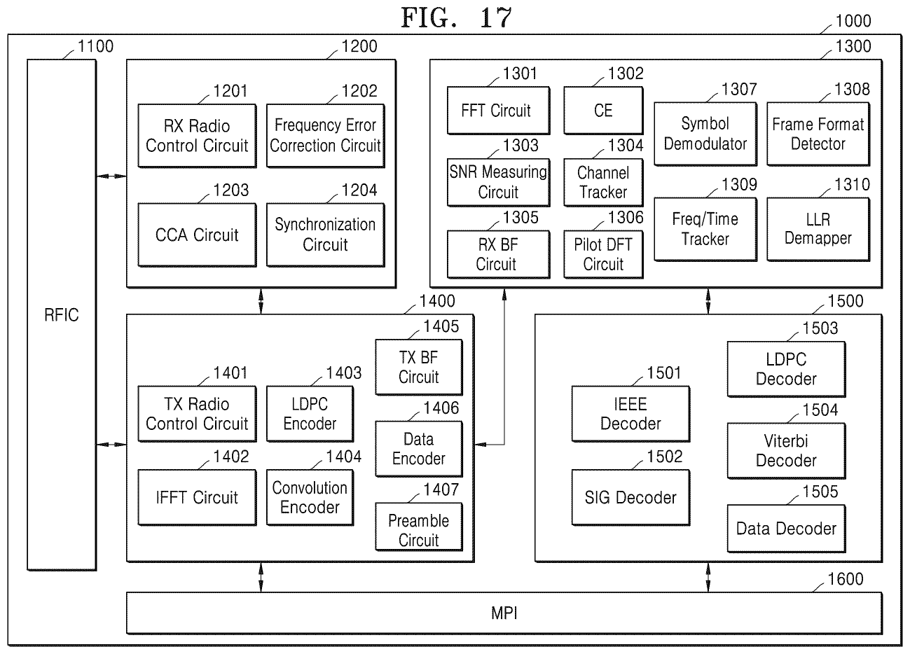

FIG. 17 is a block diagram specifically showing an apparatus 1000 according to an embodiment. The apparatus 1000 shown in FIG. 17 may be a station or an access point described above.

Referring to FIG. 17, the apparatus 1000 may include a radio frequency integrated circuit 1100, a reception circuit 1200, a demodulator 1300, a transmission circuit 1400, a processor 1500, and a MAC-PHY Interface (MPI) 1600. In FIG. 17, the respective components 1100, 1200, 1300, 1400, 1500, and 1600 are shown to be separated from each other. However, this is only an embodiment, and the disclosure is not limited to this. Some or all of the components 1100, 1200, 1300, 1400, 1500, and 1600 may be integrated into one chip (for example, a modem chip).

The reception circuit 1200 may include a receiving radio (RX radio) control circuit 1201, a frequency error correction circuit 1202, a clear-channel-assessment (CCA) circuit 1203, and a synchronization circuit 1204.

The demodulator 1300 may include a Fast Fourier Transform (FFT) circuit 1301, a channel estimator (CE) 1302, a signal-to-noise ratio (SNR) measuring circuit 1303, a channel tracker 1304, a receiving beamforming (RX BF) circuit 1305, a pilot Discrete Fourier Transform (DFT) circuit 1306, a symbol demodulator 1307, a frame format detector 1308, a frequency/time tracker 1309, and a log-likelihood ratio (LLR) demapper 1310.

The transmission circuit 1400 may include a transmitting radio (TX Radio) control circuit 1401, an inverse Fast Fourier Transform (IFFT) circuit 1402, a low-density parity-check (LDPC) encoder 1403, a convolution encoder 1404, a transmitting beamforming (TX BF) circuit 1405, a data encoder 1406, and a preamble circuit 1407.

The processor 1500 may include an institute of electrical and electronics engineers (IEEE) decoder 1501, a signal (SIG) decoder 1502, a LDPC decoder 1503, a Viterbi decoder 1504, and a data decoder 1505.

According to an embodiment, the transmission circuit 1400 may generate a MAP network frame described above by using at least one of the internal components 1401, 1402, 1403, 1404, 1405, 1406, or 1407, and output the MAP network frame through the RFIC 1100.

According to an embodiment, the processor 1500 may decode a received MAP network frame by using at least one of the internal components 1501, 1502, 1503, 1504, or 1505 to extract information required for MAP sounding. The transmission circuit 1400 may generate a NDP by using at least one of the internal components 1401, 1402, 1403, 1404, 1405, 1406, or 1407 based on the information extracted by the processor 1500, and output the NDP according to a NDP transmission order in the serial NDP transmission method through the RFIC 1100.

According to an embodiment, the decoder 1300 may estimate a channel state based on a received NDP by using at least one of the internal components 1301, 1302, 1303, 1304, 1305, 1306, 1307, 1308, 1309, or 1310 to generate channel state information. The transmission circuit 1400 may generate a MAP sounding feedback including the channel state information by using at least one of the internal components 1401, 1402, 1403, 1404, 1405, 1406, or 1407, and output the MAP sounding feedback through the RFIC 1100.

So far, embodiments have been disclosed in the drawings and specification. Specific terms used in the disclosure should be considered for purposes for describing the technical aspects of the disclosure, not for purposes for limiting the meanings or the scope of the disclosure written in the claims. Therefore, it will be understood by those of ordinary skill in the art that various modifications or other equivalent embodiments may be made from the embodiments. Accordingly, the true technical protecting range of the disclosure should be determined according to the technical aspects of the disclosure.

What is claimed is:

1. An method of a first apparatus in a wireless local area network (WLAN) system, the method comprising:
receiving, from a second apparatus, a multiple access points (MAP) network frame;
identifying, from the MAP network frame, a serial null data packet (NDP) transmission method for MAP sounding;
identifying, from the MAP network frame, a NDP transmission order of the first apparatus within a NDP transmission period; and
based on the NDP transmission order, transmitting, to a third apparatus, a first NDP within the NDP transmission period.

2. The method of claim 1, wherein the identifying the serial NDP transmission method comprises based on an indication of a MAP sounding mode in a MAP mode field of the MAP network frame, identifying an indication of the serial NDP transmission method from a NDP type subfield of a common information field of the MAP network frame.

3. The method of claim 1, wherein the identifying the NDP transmission order comprises:
identifying, from among a plurality of AP information fields of the MAP network frame, an access point (AP) information field assigned to the first apparatus; and
identifying the NDP transmission order of the first apparatus based on an arrangement order of the identified AP information field among the plurality of AP information fields.

4. The method of claim 1, wherein the identifying of the NDP transmission order comprises:
identifying, from among a plurality of AP information fields of the MAP network frame, an access point (AP) information field assigned to the first apparatus; and
identifying, from a preset subfield of the identified AP information field, the NDP transmission order of the first apparatus.

5. The method of claim 1, wherein the identifying the NDP transmission order comprises identifying, from a preset subfield of a common information field of the MAP network frame, a number of apparatuses participating in the MAP sounding.

6. The method of claim 1, further comprising transmitting a second NDP from the second apparatus to the third apparatus, based on the serial NDP transmission method.

7. The method of claim 1, wherein the second apparatus is a sharing access point (AP) configured to control the MAP sounding, and
wherein the first apparatus is a shared AP configured to participate in the MAP sounding.

8. The method of claim 1, further comprising:
transmitting, to the third apparatus, a first MAP trigger frame; and
receiving, from the third apparatus, a MAP sounding feedback related to the first MAP trigger frame.

9. An method of a first apparatus in a wireless local area network (WLAN) system, the method comprising:
determining a plurality of second apparatuses and a plurality of third apparatuses configured to participate in multiple access points (MAP) sounding, wherein the plurality of second apparatuses respectively correspond to a plurality of access points (APs) and the plurality of third apparatuses respectively correspond to a plurality of stations;
determining a serial null data packet (NDP) transmission method for the MAP sounding;
determining a NDP transmission order of the first apparatus and the plurality of second apparatuses within a NDP transmission period;
generating a MAP network frame indicating the serial NDP transmission method and the NDP transmission order; and
transmitting the MAP network frame to the plurality of second apparatuses and the plurality of third apparatuses.

10. The method of claim 9, wherein the determining the NDP transmission order comprises randomly determining the NDP transmission order of the first apparatus and the plurality of second apparatuses.

11. The method of claim 9, wherein the determining the NDP transmission order comprises determining a NDP transmission order of the plurality of second apparatuses, based on a fixed NDP transmission order of the first apparatus.

12. The method of claim 11, wherein the fixed NDP transmission order of the first apparatus is an earliest order or a latest order within the NDP transmission period.

13. The method of claim 9, further comprising, within the NDP transmission period, transmitting a plurality of NDPs from the first apparatus and the plurality of second apparatuses to the plurality of third apparatuses, based on the serial NDP transmission method and the NDP transmission order.

14. The method of claim 9, wherein the generating the MAP network frame comprises determining an arrangement order of a plurality of AP information fields, the arrangement order matching with the determined NDP transmission order, and
wherein the MAP network frame comprises the plurality of AP information fields arranged based on the arrangement order.

15. The method of claim 9, wherein the generating the MAP network frame comprises generating a plurality of AP information fields, wherein each of the plurality of AP information fields comprises a preset subfield indicating the determined NDP transmission order, and
wherein the MAP network frame comprises the plurality of AP information fields.

16. The method of claim 9, wherein the MAP network frame comprises a MAP mode field indicating one of a plurality of MAP operation modes, a common information field applied in common to the plurality of second apparatuses, a plurality of AP information fields individually applied to the plurality of second apparatuses, and a plurality of STA information fields individually applied to the plurality of third apparatuses.

17. A first apparatus comprising:
a transceiver configured to receive a multiple access points (MAP) network frame from a second apparatus; and
a processing circuit configured to:
identify a null data packet (NDP) transmission order of the first apparatus from the MAP network frame in a serial NDP transmission method for MAP sounding and determine a transmission timing of a first NDP based on the NDP transmission order, and
transmit the first NDP to a third apparatus through the transceiver, based on the determined transmission timing of the first NDP.

18. The first apparatus of claim 17, wherein the processing circuit is further configured to, based on an arrangement order of an access point (AP) information field assigned to the first apparatus in the MAP network frame, identify a NDP transmission order of the first apparatus.

19. The first apparatus of claim 17, wherein the processing circuit is further configured to identify, from a preset subfield of an access point (AP) information field assigned to the first apparatus in the MAP network frame, the NDP transmission order of the first apparatus.

20. The first apparatus of claim 17, wherein the second apparatus is a sharing access point (AP) configured to control the MAP sounding, and
wherein the first apparatus is a shared AP configured to participate in the MAP sounding.
